(19) United States
(12) Patent Application Publication
(10) Pub. No.: US 2026/0036865 A1
(43) Pub. Date: Feb. 5, 2026

(54) MULTIFUNCTIONAL TUNABLE METASURFACE USING VO2 PHASE CHANGING MATERIAL

(71) Applicant: Huawei Technologies Co., Ltd., Shenzhen (CN)

(72) Inventor: Huanhuan Gu, Nepean (CA)

(21) Appl. No.: 19/330,578

(22) Filed: Sep. 16, 2025

Related U.S. Application Data
(63) Continuation of application No. PCT/CN2023/085481, filed on Mar. 31, 2023.

(51) Int. Cl. G02F 1/19

(52) U.S. Cl. CPC G02F 1/19

(57) ABSTRACT

Some embodiments herein are directed to a tunable metasurface that can be used in terahertz frequencies, the metasurface comprising unit cells having one physical structure. The structure of the metasurface additionally allows multiple unit cells to be accessed by external stimuli for phase change inducement.

### CROSS-REFERENCE TO RELATED APPLICATION

The present application is a continuation of Patent Cooperation Treaty Application Serial No. PCT/CN2023/085481, entitled “A MULTIFUNCTIONAL TUNABLE METASURFACE USING VO2 PHASE CHANGING MATERIAL,” filed on Mar. 31, 2023, the entirety of which is incorporated by reference herein.

### TECHNICAL FIELD

The present application relates to metasurfaces and metamaterials, and in particular embodiments, to tunable or programmable metasurfaces and metamaterials including vanadium dioxide (VO2).

### BACKGROUND

Metamaterials are synthetic engineered materials with molecular structures that allow the materials to display properties that are not found in naturally occurring materials. For example, a metamaterial may be engineered to have a negative refraction index, help achieve perfect lensing or superlensing, or aid in optical camouflage. Owing to their precisely engineered structure, metamaterials can also be used to manipulate electromagnetic (EM) radiation, for example by blocking, absorbing, enhancing, or bending EM waves, in ways that go beyond what is possible with conventional materials.

Therefore, one area that metamaterials have large potential is in the field of telecommunication, as almost all telecommunication involves the transmission of electromagnetic (EM) radiation from transmitters to receivers. Other examples of areas that metamaterials may be very useful include wearable devices, infrastructures such as walls or glasses.

Metamaterials typically include multiple stacks of material layers, and for this reason may be hard to fabricate, using, for example, nanofabrication methods. For some applications, a metasurface, defined as one layer of a metamaterial, may be created instead to eliminate some of the complications associated with creating a metamaterial.

### SUMMARY

Advancements in the field of metamaterials have led to the development of digital or programmable metamaterials, which borrow from the concept of bits in order to result in a metamaterial that can exhibit different properties depending on how it has been “programmed”. A bit, or binary digit, is the smallest increment of data on a computer and can hold one of two values—1 or 0—which respectively correspond to on or off, or true or false, states. A digital metamaterial may be composed of one or more lattices of unit cells which can exhibit both 1 or 0, or “on” or “off”, states. Depending on which of the unit cells on a metamaterial surface are programmed to be “on” and which are programmed to be “off”, a single material can be used to manipulate EM radiation in different ways. For example, configuring the metamaterial to have a different coding sequence of its unit cells (e.g., in one configuration, having consecutive unit cells alternating between a coding sequence of 01010101 . . . , and in another configuration, having a coding sequence of 00110011 . . . ) may result in differences in the beam angles of the reflected EM radiation. Therefore, as will be appreciated by those skilled in the art, the metamaterial may be used for various applications, such as beam steering, by programming the unit cells to be arranged in different coding sequences.

Tuning a unit cell between an “on” and “off” state may be achieved using field-programmable gate array (FPGA) hardware. For example, a unit cell having metallic components may be connected to electrically controlled diodes or varactors, which diodes or varactors are in turn connected to the FPGA hardware. The FPGA hardware can deliver an electric current to the diode or varactor, which can turn the unit cell “on”. Without the current, the unit cell may be in the “off” state.

The unit cell may be designed to have a physical structure which results in a difference of substantially pi between the phase response of the unit cell in its on state and off state. This is because for EM waves, the maximum phase difference between waves is pi (or 180 degrees), and this pi phase difference between the unit cell in its “on” state vs. “off” state can accordingly correspond to a “0” or “1” state, as will be appreciated by those skilled in the art.

At microwave or millimeter (mm) wave frequencies, e.g., EM waves having a frequency less than 300 gigahertz (GHz), diodes or varactors may be used in order to program or tune the unit cells of a metamaterial between the on and off states. However, at wave frequencies in the terahertz (THz) range, diodes or varactors may no longer be used, as they cannot function properly with EM waves at such high frequencies.

Higher frequencies in fields like telecommunications are gaining interest and importance. For example, EM radiation having frequencies in the THz range may lead to characteristics such as a larger communication capacity, increased resistance to interference due to narrower beams and good beam directivity, compared to waves having frequencies in the microwave range. Therefore, there is a need for digital metamaterials which can work at THz frequencies.

Metasurfaces using a phase changing material, such as vanadium dioxide (VO2), for use in the THz frequencies have previously been proposed. VO2 can undergo phase transitions between an insulative state and a conductive state in response to external stimulation, and can accordingly be used as part of a unit cell to allow the unit cell to switch between a “0” state and a “1” state, without the use of diodes or varactors. Therefore, VO2 may be incorporated into the structure of a unit cell structure to create a digital metasurface. However, these proposed metasurfaces using vanadium dioxide face several issues.

In the proposed metasurfaces using VO2, the physical structure of a unit cell must vary depending on whether the unit cell is desired to be in an “on” state or an “off” state. For example, the dimensions (e.g., length or width) or position of vanadium dioxide used for a unit cell may need to be different between a unit cell in an “on” state and a unit cell in an “off” state, resulting in unit cells with different physical structures. The desired programming configuration then (e.g., whether the coding sequence of unit cells will be 101010 . . . or 010101 . . . or 11001100 . . . , etc.), must be predetermined prior to fabrication of the metamaterial or metasurface. Once the metamaterial is fabricated, the physical structure cannot be changed, and therefore the coding sequence of the unit cells cannot be changed. Therefore, in order to have a different coding sequence, e.g., to use in beam steering applications, an entirely new metamaterial or metasurface having the newly desired configuration must be fabricated, making it impractical for use in such cases.

Furthermore, the proposed metasurfaces using VO2 do not provide an easy or practical way to initiate the phase change of the VO2. For example, the designs of the proposed metasurfaces are such that in order to induce the insulator-metallic phase change of the VO2 components on multiple unit cells of a metasurface, each of the unit cells must be individually accessed by external stimuli, since the VO2 elements of consecutive unit cells are not connected to each other. Therefore, an external stimulator used to induce the insulator-metallic phase change must have connection means (e.g., wires) with every single unit cell.

Therefore, there is a need for a tunable metasurface for use in the THz frequency, which can be more easily tuned to have different coding sequences.

Some embodiments herein are directed to a tunable metasurface or metamaterial. For simplicity, when the term “metasurface” is used henceforth, it may be used to refer to both the metasurface and a metamaterial that is made from layers of the metasurface.

The tunable metasurface may include an arrangement of unit cells, each unit cell structure including a phase change material, such as VO2. The unit cell may have one single physical structure and may be programmable to be in an “on” or “off” state. Furthermore, the VO2 elements between consecutive unit cells along a certain direction may be physically connected, allowing multiple unit cells to be manipulated by external stimulation applied to one of the multiple unit cells.

The tunable metasurface may be implemented for applications which require the reflection and/or transmission of EM radiation. For example, the reflection of EM radiation achieved by the tunable metasurface may be useful in applications which require beam steering, and the transmission of EM radiation achieved by the tunable metasurface may be useful in applications which require beam filtering. The tunable metasurface may be implemented for use with lower frequency EM radiation as well, e.g., instead of using diodes or varactors.

In some embodiments, there is provided a unit cell for a metasurface or metamaterial. The unit cell may alternatively be called a tunable unit cell, or a programmable unit cell. The unit cell may include a substrate comprising a top layer and a bottom layer. The top layer may have thereon a first top layer strip of vanadium dioxide and a second top layer strip of vanadium dioxide spaced apart from the first top layer strip of vanadium dioxide, each of the first top layer strip of vanadium dioxide and the second top layer strip of vanadium dioxide including a first side and an opposite side. The first side of the first top layer strip may face towards the first side of the second top layer strip, the opposite second side of the first top layer strip may face away from the second top layer strip, and the opposite second side of the second top layer strip may face away from the first top layer strip. The opposite second side of the first top layer strip and the opposite second side of the second top layer strip may each have a plurality of spaced apart protrusions of vanadium dioxide protruding therefrom. The top layer may further have thereon a plurality of top layer metal bands spaced apart from each other, each of the plurality of top layer metal bands extending from the first side of the first top layer strip to the first side of the second top layer strip. The bottom layer may have thereon a first bottom layer strip of vanadium dioxide and a second bottom layer strip of vanadium dioxide spaced apart from the first bottom layer strip of vanadium dioxide, each of the first bottom layer strip of vanadium dioxide and the second bottom layer strip of vanadium dioxide including a first side and an opposite second side. The first side of the first bottom layer strip may face towards the first side of the second bottom layer strip, the opposite second side of the first bottom layer strip may face away from the second bottom layer strip, and the opposite second side of the second bottom layer strip may face away from the first bottom layer strip. The bottom layer may further have thereon a plurality of bottom layer bands of vanadium dioxide spaced apart from each other, each of the plurality of bottom layer bands of vanadium dioxide extending from the first side of the first bottom layer strip of vanadium dioxide to the first side of the second bottom layer strip of vanadium dioxide. The bottom layer may further have thereon a plurality of bottom layer metal bands spaced apart from each other and interposed between the first side of the first bottom layer strip of vanadium dioxide and the first side of the second bottom layer strip of vanadium dioxide. Each of the plurality of bottom layer metal bands may also be spaced apart from: the first bottom layer strip of vanadium dioxide, the second bottom layer strip of vanadium dioxide, and the plurality of bottom layer bands of vanadium dioxide.

In some embodiments, there is provided a metasurface having a repeating pattern of unit cells. Each unit cell may include a substrate comprising a top layer and a bottom layer. The top layer of each unit cell may have thereon a first top layer strip of vanadium dioxide and a second top layer strip of vanadium dioxide spaced apart from the first top layer strip of vanadium dioxide, each of the first top layer strip of vanadium dioxide and the second top layer strip of vanadium dioxide including a first side and an opposite second side. The first side of the first top layer strip may face towards the first side of the second top layer strip, the opposite second side of the first top layer strip may face away from the second top layer strip, and the opposite second side of the second top layer strip may face away from the first top layer strip. The opposite second side of the first top layer strip and the opposite second side of the second top layer strip may each have a plurality of spaced apart protrusions of vanadium dioxide protruding therefrom. The top layer of each unit cell may further have thereon a plurality of top layer metal bands spaced apart from each other, each of the plurality of top layer metal bands extending from the first side of the first top layer strip to the first side of the second top layer strip. The bottom layer of each unit cell may have thereon a first bottom layer strip of vanadium dioxide and a second bottom layer strip of vanadium dioxide spaced apart from the first bottom layer strip of vanadium dioxide, each of the first bottom layer strip of vanadium dioxide and the second bottom layer strip of vanadium dioxide including a first side and an opposite second side. The first side of the first bottom layer strip may face towards the first side of the second bottom layer strip, the opposite second side of the first bottom layer strip may face away from the second bottom layer strip, and the opposite second side of the second bottom layer strip may face away from the first bottom layer strip. The bottom layer of each unit cell may further have thereon a plurality of bottom layer bands of vanadium dioxide spaced apart from each other, each of the plurality of bottom layer bands of vanadium dioxide extending from the first side of the first bottom layer strip of vanadium dioxide to the first side of the second bottom layer strip of vanadium dioxide. The bottom layer of each unit cell may further have thereon a plurality of bottom layer metal bands spaced apart from each other and interposed between the first side of the first bottom layer strip of vanadium dioxide and the first side of the second bottom layer strip of vanadium dioxide. Each of the plurality of bottom layer metal bands may also be spaced apart from: the first bottom layer strip of vanadium dioxide, the second bottom layer strip of vanadium dioxide, and the plurality of bottom layer bands of vanadium dioxide.

Technical benefits of some embodiments may include the ability to tune or program a single metasurface which has an arrangement (e.g., lattice or grid) of unit cells into different configurations (e.g., different coding sequences) using external stimulation means. The different configurations achievable using a single metasurface may result in the metasurface being able to reflect or transmit beams depending on the desired application, and further being able to reflect beams having different angles for applications such as beam steering. Further, physical contact between some of the phase-changing material elements in consecutive tunable unit cells may allow for multiple consecutive unit cells (e.g., a column of unit cells) to be manipulated by external stimulation applied to only one of the multiple unit cells, thereby making it easier and more cost efficient to tune the unit cells of the metasurface.

### BRIEF DESCRIPTION OF THE DRAWINGS

Embodiments will be described, by way of example only, with reference to the accompanying figures wherein:

FIG. 1 illustrates a top view of a tunable unit cell, according to some embodiments;

FIG. 2 illustrates a bottom view of the tunable unit cell of FIG. 1, according to some embodiments;

FIG. 3 illustrates the tunable unit cell of FIG. 1 in a first reflective state, a second reflective state, and a transmissive state, according to some embodiments;

FIG. 4 shows a graph illustrating the reflection amplitude of electromagnetic (EM) radiation reflected by the tunable unit cell of FIG. 3 in the first and second reflective states at various frequencies of incident EM radiation, according to some embodiments;

FIG. 5 shows a graph illustrating the phase response displayed by the tunable unit cell of FIG. 3 in the first and second reflective states at various frequencies of incident EM radiation, according to some embodiments;

FIG. 6 shows a graph illustrating the transmission amplitude displayed by the tunable unit cell of FIG. 3 in the transmissive state at various frequencies of incident EM radiation, according to some embodiments;

FIGS. 7-9 illustrate various configurations of a tunable metasurface comprising a lattice of the tunable unit cells of FIG. 3;

FIG. 10 illustrates simulated reflective far-field scattering patterns of the metasurface of FIG. 7, according to some embodiments;

FIG. 11 illustrates simulated reflective far-field scattering patterns of the metasurface of FIG. 8, according to some embodiments; and

FIG. 12 illustrates simulated transmissive far-field scattering patterns of the metasurface of FIG. 9, according to some embodiments.

### DETAILED DESCRIPTION

For illustrative purposes, specific embodiments will now be explained in greater detail below in conjunction with the figures.

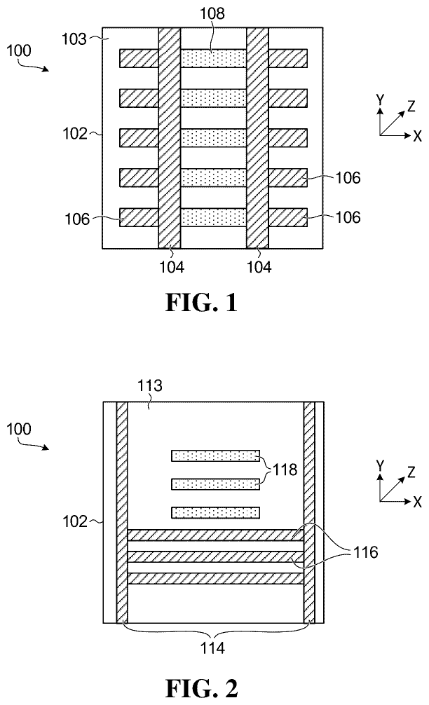

FIGS. 1 and 2 respectively illustrate a top view and a bottom view of a unit cell 100, according to some embodiments. As shown, unit cell 100 comprises a substrate 102 having a top surface 103 and a bottom surface 113. In a preferred embodiment, the substrate 103 may be polyimide. In some embodiments, the substrate 103 may be another material, e.g., sapphire.

Various elements are disposed on the top surface 103 and the bottom surface 113 of the unit cell 100. Specifically, on the top surface 103, a plurality of strips 104, a plurality of protrusions 106, and a plurality of bands 108 may be disposed. On the bottom surface 113, a plurality of strips 114, a plurality of bands 116, and a further plurality of bands 118, may be disposed. Note that the terms “bands” and “strips” may be used interchangeably. Two different terms are adopted simply to help with ease of explanation, e.g., by calling strips in one direction “strips” and calling strips in another direction “bands”.

The plurality of strips 104 and the plurality of protrusions 106 disposed on the top surface 103, as well as the plurality of strips 114 and plurality of bands 116 disposed on the bottom surface 113, may be composed of a phase-transition element. In a preferred embodiment, the phase-transition element may be vanadium dioxide (VO2).

VO2 is an element which can experience rapid insulator-metal phase transitions in response to external stimuli (e.g., stimuli of an optical, electrical, or thermal nature). This is due to its crystalline structure which can undergo changes at approximately 67 degrees Celsius (152.6 degrees Fahrenheit). Specifically, below this threshold temperature VO2 displays properties of an insulator, while above it VO2 displays the properties of a conductor. As will be appreciated by those skilled in the art, when vanadium dioxide is in its conductive state it is able to reflect electromagnetic radiation, and when vanadium dioxide is in its insulative state it is able to transmit electromagnetic radiation.

The plurality of bands 108 disposed on the top surface 103 and the plurality of bands 118 disposed on the bottom surface 113 may be composed of a metal element. In a preferred embodiment, the metal element may be gold. In some other embodiments, the metal element may be another metal, e.g. chromium.

The plurality of strips 104, plurality of protrusions 106, plurality of bands 108, plurality of strips 114, plurality of bands 116, and plurality of bands 118, may be disposed onto the top surface 103 or bottom surface 113 of unit cell 100 using known fabrication methods, such as printing or deposition.

In a preferred embodiment, as illustrated in FIG. 1, the top surface 103 of the unit cell 100 may have disposed thereon two spaced apart vanadium dioxide strips 104, five spaced apart vanadium dioxide protrusions 106 protruding from an outer side (e.g., “second side”) of each of the vanadium dioxide strips 104, and five spaced apart gold bands 108 each extending between and connected to an inner side (e.g., “first side”) of each of the vanadium dioxide strips 104.

In a preferred embodiment, as shown in FIG. 2, the bottom surface 113 of the unit cell 100 may have disposed thereon two spaced apart vanadium dioxide strips 114, three spaced apart vanadium dioxide strips 116 each extending between and connected to an inner side (e.g., “first side”) of each of the vanadium dioxide strips 114, and three spaced apart gold bands 118 disposed between but not connected to the inner side of either of the vanadium dioxide strips 114. Each of the three gold bands 118 may also be spaced apart from the three spaced apart vanadium dioxide strips 116.

Dimensions associated with the unit cell 100 may be as follows, described with respect to the illustrated x-y-z axes for ease of reference. Specifically, the “length” of a component refers to a measurement along the y-direction, the “width” of a component refers to a measurement along the x-direction, and the “height” or “thickness” of a component refers to a measurement along the z-direction.

In some embodiments, the unit cell 100 may be 100 μm in length, 100 μm in width, and 35 μm in thickness. With respect to top surface 103, the two VO2 strips 104 may be substantially parallel to each other and substantially parallel to the length edge of the unit cell 100. The VO2 protrusions 106 protruding from each of the two VO2 strips and the gold bands 108 may be substantially perpendicular to the two VO2 strips 104 and substantially parallel to each other and to the width edge of the unit cell 100. Each of the two VO2 strips 104 may be 100 um in length, i.e., spanning the entire length of the unit cell, 10 um in width, and 0.2 um in thickness. Each of the VO2 protrusions 106 may be 10 um in length, 15 um in width, and 0.2 um in thickness. Each of the gold bands 108 may be 10 um in length, 40 um in width, and 0.2 um in thickness.

With respect to the bottom surface 113, the two VO2 strips 114 may be substantially parallel to each other and substantially parallel to the length edge of the unit cell 100. The three VO2 bands 116 and the three gold bands 118 may be substantially perpendicular to the two VO2 strips 114 and substantially parallel to each other and to the width edge of the unit cell 100. Each of the two VO2 strips 114 may be 100 um in length, 5 um in width, and 0.2 um in thickness. Each of the three VO2 bands may be 5 um in length, 80 um in width, and 0.2 um in thickness. Each of the gold bands 118 may be 5 um in length, 60 um in width, and 0.2 um in thickness.

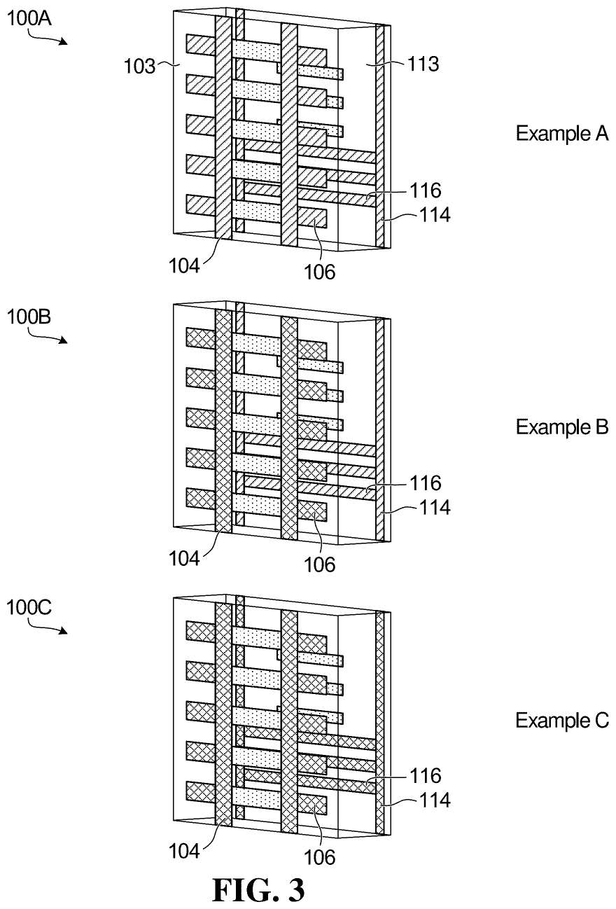

FIG. 3 illustrates the unit cell 100 in various reflective and transmissive states, according to some embodiments. Specifically, Example A of FIG. 3 illustrates the unit cell 100 in a first reflective state 100A, Example B illustrates the unit cell 100 in a second reflective state 100B, and Example C illustrates the unit cell 100 in a transmissive state 100C. The physical structure of the unit cell 100 is identical between the unit cell in the first reflective state 100A, second reflective state 100B, and transmissive state 100C. The only difference between the states 100A, 100B and 100C is whether the vanadium dioxide components are in a conductive state or an insulative state.

In the first reflective state 100A, all of the VO2 elements on the top surface 103 of the unit cell 100, namely the VO2 strips 104 and the VO2 protrusions 106, are in the conductive state. Similarly, all of the VO2 elements on the bottom surface 113 of the unit cell 100, namely the VO2 strips 114 and the VO2 bands 116, are in the conductive state. In the second reflective state 100B, all of the VO2 elements on the top surface 103 are in the insulative state, while all of the VO2 elements on the bottom surface 113 are in the conductive state. In the transmissive state 100C, all of the VO2 elements on both the top surface 103 and bottom surface 113 are in the insulative state.

As discussed previously, the VO2 elements of the unit cell can transition between their conductive and insulative states using external stimulation. In some embodiments, this external stimulation may be provided using a field-programmable gate array (FPGA) controller (not shown). One or more control lines (not shown) may be used to connect the FPGA controller to the unit cell 100. In some embodiments, the one or more control lines may be copper wires. In some embodiments, for example, each one of the top surface VO2 strips 104 and bottom surface VO2 strips 114 may be connected via a corresponding control line to the FPGA controller. As will be appreciated by those skilled in the art, the FPGA controller may send an electrical signal through a control line, which signal can excite the vanadium dioxide and induce in it a phase change from its insulative state to its conductive state. For example, a switch may be toggled between an on and off mode to control whether an electrical signal is sent via a corresponding control line. In this way, all of the VO2 elements of a unit cell can be programmed or tuned between a conductive state and insulative state using four control lines.

For the unit cell 100 depicted in FIGS. 1-3, since there are two VO2 strips 104 on the top surface 103 and two VO2 strips 106 on the bottom surface 113, four control lines may be used to connect the FPGA controller to the unit cell 100. Since each of the top surface VO2 protrusions 106 is in physical contact with one of the top surface VO2 strips 104, and each of the VO2 bands 116 is in physical contact with both of the VO2 strips 114, the four control lines may be used to affect the phase change of all of the VO2 elements of the unit cell 100 (i.e., two control lines can be used to induce phase transitions in the VO2 strips 104 and VO2 protrusions 106 on the top surface 103, and two other control lines can be used to induce phase transitions in the VO2 strips 114 and VO2 bands 106 on the bottom surface 113).

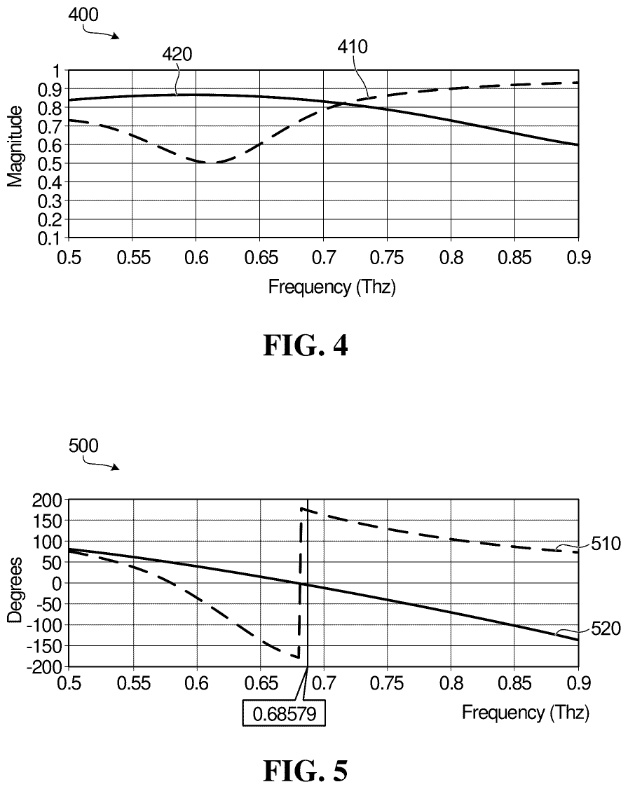

FIGS. 4-6 illustrate graphs illustrating the reflection magnitude, the phase response, or the transmission magnitude of the unit cell 100 in its various reflective and transmissive states. The magnitude or phase response measurements may be simulated by an electromagnetic field simulation software such as CST Studio Suite®, or may be physically measured by a vector signal analyzer.

FIG. 4 shows a graph 400 illustrating the reflection amplitude of EM radiation reflected by the unit cell 100 in the first reflective state 100A and the second reflective state 100B. In some embodiments, EM radiation of various frequencies, i.e., different wavelengths, are directed towards the unit cell 100 in the first reflective state 100A and in the second reflective state 100B, and the magnitude of the radiation reflected by the unit cell 100 is measured. For example, in graph 400 the frequency of the EM radiation ranges between 0.5 THz and 0.9 THz. Curve 410 represents the reflection magnitude of the unit cell 100 in the first reflective state 100A, and curve 420 represents the reflection magnitude of the unit cell 100 in the second reflective state 100B. Since the unit cell at both first and reflective states 100A, 100B, have at least some of the VO2 elements in the conductive state, graph 400 shows high reflectivity for both curves 410, 420.

FIG. 5 shows a graph 500 illustrating the phase response of the unit cell 100 in the first reflective state 100A and the second reflective state 100B. In some embodiments, EM radiation of various frequencies are directed towards the unit cell 100 in the first reflective state 100A and in the second reflective state 100B, and the phase of the reflected radiation is measured. In graph 500 the frequency of the EM radiation ranges between 0.5 THz and 0.9 THz, with curve 510 representing the reflection phase of the unit cell 100 in the first reflective state 100A, and curve 520 representing the reflection phase of the unit cell 100 in the second reflective state 100B. In the illustrated example, at a frequency of 0.68579 THz, the measured phase response of the reflected EM radiation between the unit cell 100 in the first reflective state 100A and the unit cell 100 in the second reflective state 100B differs by substantially pi, i.e., about 180 degrees. More generally, at a frequency range between approximately 0.65 THz and 0.9 THz, it can be observed that the measured phase response between the unit cell 100 in the first reflective state 100A and the unit cell 100 in the second reflective state 100B differs by substantially pi. Note that the term “substantially pi”, as used herein, means the intention is for the phase difference to be generally at or around pi, but exactly pi is not necessary, e.g. a variation of +/−40 degrees may be possible. For example, in FIG. 5 at 0.9 THz the phase difference is about 215 degrees. As will be appreciated by those skilled in the art, this substantially pi phase difference effectively allows the unit cell in the first reflective state 100A to exhibit a “1” or “on” state and the unit cell in the second reflective state 100B to exhibit a “o” or “off” state. This substantially pi phase difference may allow for desirable constructive and/or destructive interference effects between radiation beams reflected by a metasurface of the present application, for applications such as beam steering.

Indeed, in some embodiments, the structure of the unit cell 100 described above, including the dimensions of the unit cell 100, the specific elements used (e.g., VO2 and gold), the number of vanadium dioxide strips 104 and protrusions 106 and gold bands 108 to be placed on the top surface 103, and the number of vanadium dioxide strips 114 and bands 116 and gold bands 118 to be placed on the bottom surface 113, and each of their dimensions and the spacing relative to each other, may be chosen specifically to result in a substantially pi phase difference between the unit cell in the first reflective state 100A and the unit cell in the second reflective state 100B. In some embodiments, the structure of the unit cell 100, such as the elements, dimensions of elements, spacings between elements, etc., may be adjusted in different ratios to still achieve the substantially pi phase difference between a first reflective state 100A and second reflective state 100B. Therefore, the specific structure illustrated in FIGS. 1 and 2 is only one embodiment, and the exact illustrated structure need not be necessary. For example, the number of strips and/or bands and/or protrusions, and/or their dimensions and/or their spacing relative to each other may be varied, keeping in view the goal of achieving the substantially pi phase difference between a first reflective state and a second reflective state. Variations may also or instead be provided in the structure that might not result in a substantially pi phase difference, but still might operate suitably well, depending upon the scenario. For example, the phase difference might not be close to pi, but the phase difference may be notable enough to still operate suitably well.

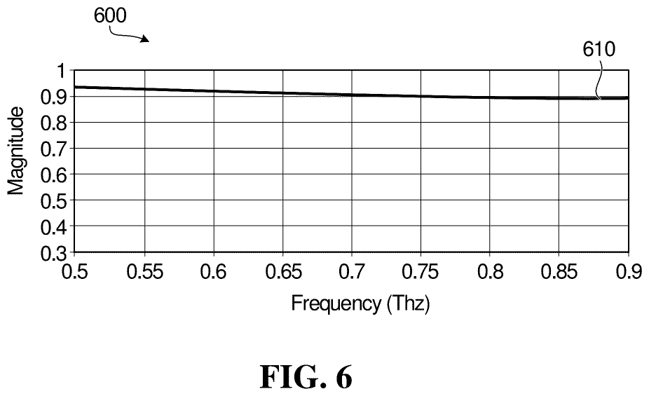

As described previously, in the transmissive state 100C, all of the VO2 elements of unit cell 100 are in the insulative state, and therefore the unit cell 100 is able to much better transmit EM radiation as compared to the unit cell 100 in the first and second reflective states 100A, 100B. FIG. 6 shows a graph 600 illustrating the transmission amplitude of EM radiation reflected by the unit cell 100 in the transmissive state 100C. EM radiation of various frequencies are directed towards the unit cell 100 in the transmissive state 100C and the amplitude of the transmitted radiation is measured. As shown, the magnitude of the transmitted EM radiation remains relatively high throughout a frequency range for the EM radiation between 0.5 and 0.9 THz.

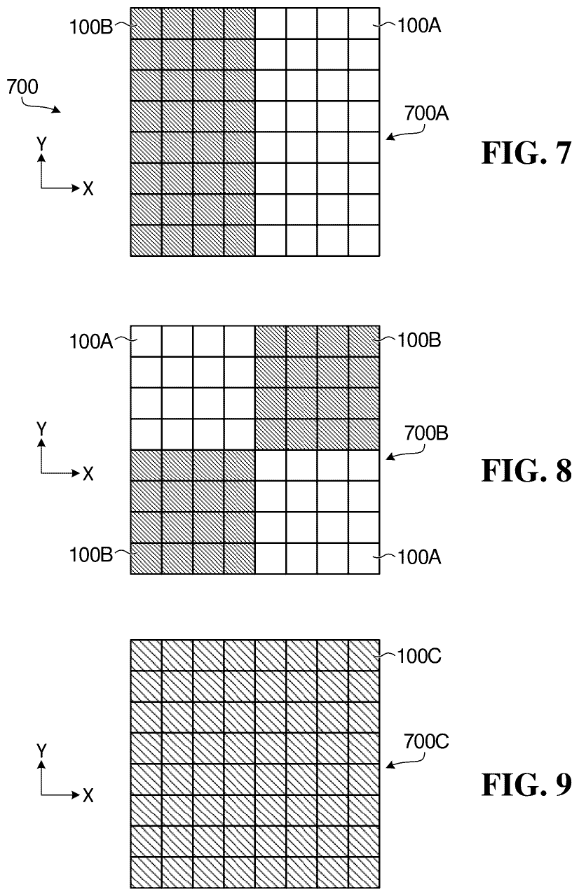

FIGS. 7-9 illustrate various configurations of a tunable metasurface 700 comprising a lattice or grid of tunable unit cells 100. The metasurface 700 can generally comprise an arrangement of M×N unit cells 100, where M and N are whole numbers greater than o, and M might or might not equal N. The metasurface 700 in FIGS. 7-9 is shown to comprise an 8x8 lattice of tunable unit cells 100, but this is only an example. A large lattice might be deployed in implementation, depending upon the application. As shown, the metasurface 700 in FIGS. 7-9 comprises arrays of consecutive unit cells 100 in rows and columns. In some embodiments, the substrate 102 may be a continuous layer (e.g., made of polyimide) which is sized to accommodate the number of desired unit cells, and the necessary VO2 and gold elements may be printed or deposited on the top surface and bottom surface of the substrate 102. For example, for the metasurface 700 in FIGS. 7-9, the dimensions of the substrate, and thereby the dimensions of the metasurface 700, may be 800 um in length, 720 um in width, and 39 um in thickness. The metasurface size may change depending on the application. For example, for the application of smartphones, the metasurface may range between 1 mm length and width to 1 cm length and width.

Returning briefly to FIGS. 1-3, on the top surface 103 of the unit cell 100, the VO2 strips 104 extend the full length of the unit cell and therefore each of the VO2 strips 104 reach both edges of the top surface 103 along the y-direction, while the VO2 protrusions 106 do not extend to reach either of the edges of the top surface 103 along the x-direction. Similarly, on the bottom surface 113 of the unit cell 100, the VO2 strips 114 extend to reach both edges of the bottom surface 113 along the y-direction, while the VO2 bands 116 do not extend to reach either of the edges of the bottom surface 113 along the x-direction. Therefore, when the unit cells 100 are arranged to form a metasurface, such as metasurface 700 in FIGS. 7-9, the physical structure of the metasurface may be such that along each column of unit cells 100 along the y-direction, each one of the two VO2 strips 104 in a particular unit cell 100 is physically connected to a corresponding VO2 strip 104 of the unit cell immediately above and also to a corresponding VO2 strip 104 of the unit cell immediately below the particular unit cell. For the first and last unit cells 100 in each column, each VO2 strip 104 is respectively only physically connected to a corresponding VO2 strip immediately below or immediately above. Therefore, the top surface VO2 strips 104 and the bottom surface VO2 strips 114 of the unit cells 100 along a metasurface column may form continuous lines which extend along the entire length of the metasurface.

This structure of connected lines of VO2 strips 104 on the top surface of the metasurface 700 and connected lines of VO2 strips 114 on the bottom surface of the metasurface 700 may advantageously allow a plurality of unit cells to be tunable at once between the first reflective state 100A, second reflective state 100B, and transmissive state 100C. For example, if using a FPGA controller with control lines to tune the unit cells between the various states, an entire column of unit cells 100 may be tunable at once using the control lines required to tune a single unit cell 100. For instance, as described previously, four control lines may be used to tune a single unit cell 100, with a first control line connected to one of the VO2 strips 104, a second control line connected to the other one of the VO2 strips 104, a third control line connected to one of the VO2 strips 114, and a fourth control line connected to the other one of the VO2 strips 114. Since on the bottom surface 113 of a unit cell, VO2 strips 114 are also physically connected to the VO2 bands 116, in some embodiments, three control lines may be used to tune the unit cell 100 since only one control line may be used for the bottom surface as opposed to two. In a preferred embodiment, the four control lines may be used. Using two control lines for the bottom layer VO2 strips 114, as opposed to one, may be done for increasing performance of the external stimulator, e.g., to make the tuning of the unit cell more robust. Due to the ability of vanadium dioxide to conduct electricity, if the control lines are connected to the VO2 strips 104, 114 of the bottommost unit cell 100 of a metasurface column, the electric signal sent by the FPGA controller can communicate with all of the unit cells 100 in the metasurface column by way of the continuous lines of the VO2 strips 104, 114. Without this connection of some VO2 elements between subsequent unit cells in a metasurface column, four control lines may be required for each unit cell in a metasurface, which may be impractical when a metasurface comprises many unit cells.

The physical structure of the metasurface 700 remains identical between the illustrations shown at FIGS. 7-9. The difference lies in whether the unit cells 100, which make up the metasurface, are programmed or tuned to be in the first reflective state 100A, the second reflective state 100B, or the transmissive state 100C. Specifically, in FIG. 7, the metasurface 700 is in a first programmed state 700A; in FIG. 8, the metasurface 700 is in a second programmed state 700B, and in FIG. 9, the metasurface 700 is in a third programmed state 700C. Therefore, the physical structure of the metasurface 700 or unit cells 100 advantageously need not be changed to be tuned to be in various programmed states.

As shown in FIG. 7, the first programmed state 700A comprises four consecutive columns of unit cells 100 all programmed or tuned to be in the second reflective state 100B, and four consecutive columns of unit cells 100 all tuned to be in the first reflective state 100A. This type of metasurface configuration, where all of the unit cells 100 in a column are uniformly tuned to be in either the first reflective state 100A or second reflective state 100B may be called a banded configuration.

A period T for a metasurface can be described as the number of consecutive unit cells tuned to be in the same first reflective state 100A or second reflective state 100B, along either the x-direction or the y-direction. For example, for the metasurface 700 as configured in the embodiment illustrated in FIG. 7, the period in the x-direction, Tₓ, is 4.

In a banded configuration, all of the unit cells 100 in one column can be tuned as described above, e.g., by use of four control lines connected to a FPGA controller. For the metasurface 700 in FIG. 7, for example, four control lines may be used for each column of the metasurface 700, and therefore a total of 32 control lines may be used to tune all of the unit cells 100 in metasurface 700 in the first programmed state 700A. Specifically, to tune a column of unit cells to be in the second reflective state 100B (e.g., for each of the four left columns in FIG. 7), the FPGA controller may send electric signals through the two control lines connected to top surface VO2 strips 104, while not sending electric signals through the two control lines connected to bottom surface VO2 strips 114. In this way, the insulator-metal phase change may only be realized for the top surface VO2 strips 104 and VO2 protrusions 106, and not for the bottom surface VO2 strips 114 and VO2 bands 116, resulting in the situation shown in Example B of FIG. 3 for each of the unit cells in the column. To tune a column of unit cells to be in the first reflective state 100A (e.g., for each of the four right columns in FIG. 7), the FPGA controller may send electric signals through all four control lines connected to top surface VO2 strips 104 and bottom surface VO2 strips 114. In this way, the insulator-metal phase change may be realized for all of the VO2 elements in the column, resulting in the situation shown in Example A of FIG. 3 for each of the unit cells in the column.

In FIG. 8, the metasurface 700 in the second programmed state 700B comprises a repeated pattern of a 4×4 array of consecutive unit cells all tuned to be in the first reflective state 100A followed by 4×4 array of consecutive unit cells all tuned to be in the second reflective state 100B, thus having a period in the x-direction Tₓ of 4, and a period in the y-direction T_{y} of 4. This type of metasurface configuration may be called a cross tiled configuration.

In a cross tiled configuration, since not all of the unit cells in a column are tuned to be in the same reflective state or same transmissive state, additional control lines may be needed to properly program the unit cells along a column. For example, for the configuration shown in FIG. 8 where the period in the y-direction is 4, four control lines may be used for each sub-column of four unit cells. Therefore, for metasurface 700 in the second programmed state 700B, a total of 64 control lines may be used to tune all of the unit cells 100 in the metasurface. If the metasurface needs to be programmable between banded (e.g. shown in FIG. 7) and cross tiled (e.g. shown in FIG. 8), then the metasurface would need to be provided with the number of control lines necessary to achieve the cross tiled configuration.

In some embodiments, to beam steer in the x direction, periodicity of columns in the x direction is used (e.g. the banded configuration of FIG. 7). In some embodiments, to beam steer in the y direction, periodicity of rows in the y direction is used. In some embodiments, to beam steer in both the x and y directions, then periodicity of both columns in the x direction and rows in the y direction are used (e.g. the cross tiled configuration of FIG. 8), and the periodicity of x and y may be different even though they are illustrated as being the same in the example in FIG. 8.

In FIG. 9, the metasurface 700 in the third programmed state 700C comprises all of the unit cells 100 in the metasurface 700 tuned to be in the transmissive state 100C. This type of metasurface configuration may be called a uniform configuration. Similar to the banded metasurface configuration, since all of the unit cells 100 in one column is tuned to be in the same state, in this embodiment the transmissive state 100C, four (or three) control lines may be used for each column of the metasurface 700, and a total of 32 control lines may be used to tune all of the unit cells 100 in metasurface 700 in the third programmed state 700C.

The configuration of the metasurface 700 in FIGS. 7-9 are only examples of possible programmed configurations of the metasurface. Since the physical structure of the metasurface 700 may remain the same, there may be flexibility and freedom in designing a variety of programmed states, e.g., banded configurations having different periodicities Tₓ, and cross tiled structures having different periodicities Tₓ and/or T_{y}, although more flexibility in cross tiled structures would require more control lines. In some embodiments, Tₓ and/or T_{y} may change one or more times throughout the metasurface structure, i.e., the programmed configuration of the metasurface may not be uniformly periodic throughout in the x-direction and/or the y-direction.

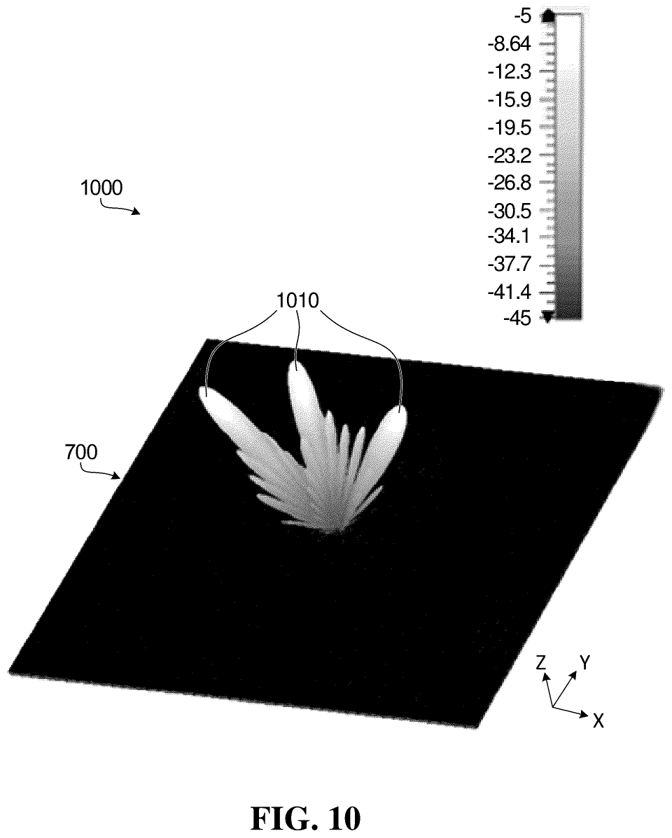

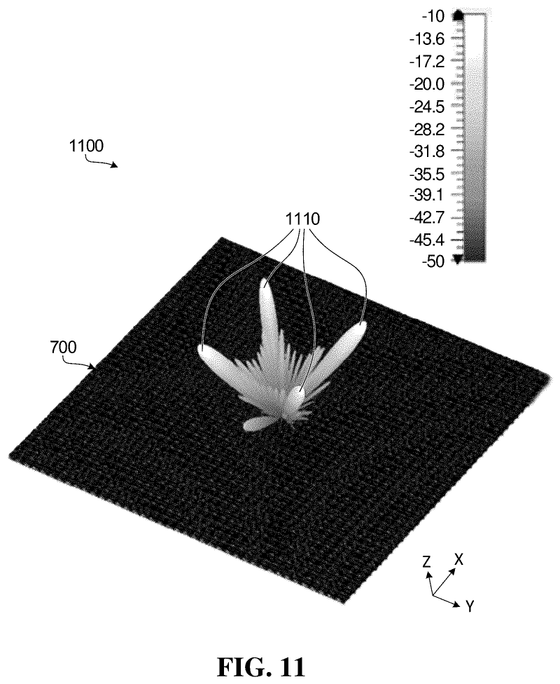

FIGS. 10 and 11 respectively illustrate simulated reflective far-field scattering patterns of the metasurface 700 configured in different programmed states as shown in FIGS. 7 and 8.

FIG. 10 shows simulated reflective far-field scattering patterns of the metasurface 700 in the first programmed state 700A as shown in FIG. 7. In some embodiments, an incident beam of EM waves may be directed towards the metasurface 700 in the first programmed state 700A, along the z-direction. The metasurface 700 in the first programmed state 700A may reflect the EM waves as shown in FIG. 10, with multiple main beam directions 1010 each having an angle of deflection with respect to the incident beam.

FIG. 11 shows simulated reflective far-field scattering patterns of the metasurface 700 in the second programmed state 700B as shown in FIG. 8. In some embodiments, an incident beam of EM waves may be directed towards the metasurface 700 in the second programmed state 700B, along the z-direction. The metasurface 700 may reflect the EM waves as shown in FIG. 11, with multiple main beam directions 1110 each having an angle of deflection with respect to the incident beam.

As apparent in the illustrations in FIG. 10 and FIG. 11, the deflection angles of the main beam directions 1010 of FIG. 10 are different to the deflection angles of the main beam directions 1110 of FIG. 11. These differences in deflection angles may be caused by altering the programming configuration of metasurface 700 from first programmed state 700A to second programmed state 700B, i.e., from the banded configuration in FIG. 7 to the cross tiled configuration in FIG. 8. Therefore, the metasurface 700 (and in general, a metasurface comprised of any number of unit cells 100) may be programmed to be able to steer the reflected beams in desired directions along the x- and y-directions.

In some embodiments, the angle of deflection may be manipulated and the resulting reflected beam may be steered according to the formula

$$θ = {sin}^{- 1} ( λ / T )$$

where θ is the angle of deflection, λ is the wavelength of the incident beam, and Tis the period in the x-direction or the y-direction.

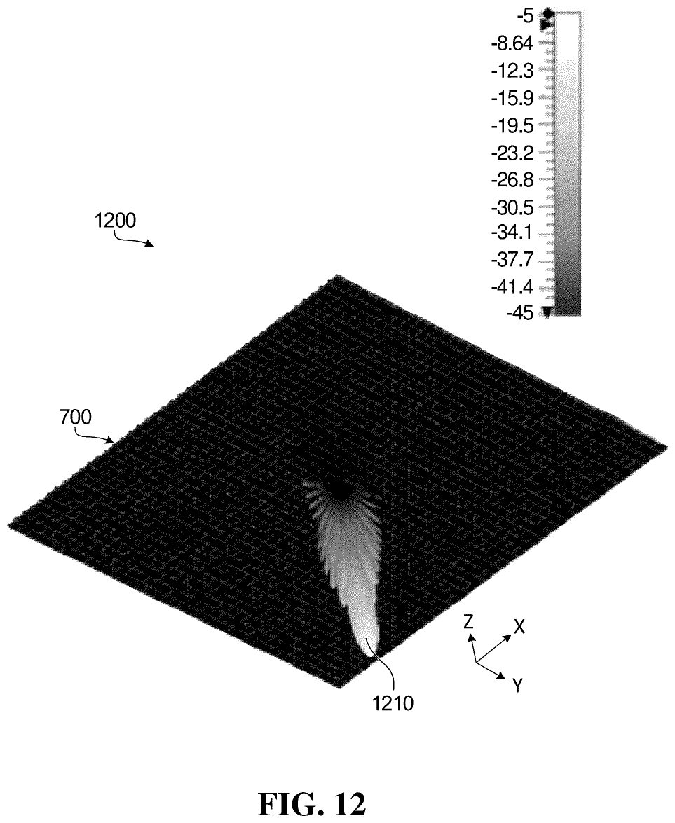

FIG. 12 illustrates simulated transmissive far-field scattering patterns of the metasurface 700 in the third programmed state 700C as shown in FIG. 9. In some embodiments, an incident beam of EM waves may be directed towards the metasurface 700 in the third programmed state 700C, along the z-direction. The metasurface 700 may transmit the EM waves as shown in FIG. 12, with a main beam direction 1210.

The embodiments above relate to a tunable unit cell having VO2 as part of its structure and a tunable metasurface comprising a plurality of the tunable unit cells. The tunable metasurface allows EM radiation having terahertz wave frequencies to be manipulated in various ways without having to change the physical structure of the metasurface. Further, the structure of the unit cell allows for multiple unit cells to be tuned at once between a first reflective state, second reflective state, and transmissive state, using external stimulation.

As mentioned above, the specific structure of a unit cell illustrated in FIGS. 1 and 2 is just one example. More generally, the top layer 103 may include a first top layer strip of a phase-transition material (e.g. VO2) and a second top layer strip of the phase-transition material (e.g. VO2) spaced apart from the first top layer strip, e.g. strips 104. Each of the first top layer strip and the second top layer strip may include a first side (e.g. inner side) and an opposite second side (e.g. outer side). The first side of the first top layer strip may face towards the first side of the second top layer strip. The opposite second side of the first top layer strip may face away from the second top layer strip. The opposite second side of the second top layer strip may face away from the first top layer strip. The opposite second side of the first top layer strip and the opposite second side of the second top layer strip may each have a plurality of spaced apart protrusions of VO2, e.g., protrusions 106, protruding therefrom. The top layer 103 may further include a plurality of top layer metal bands, e.g., bands 108, spaced apart from each other, each of the plurality of top layer metal bands extending from the first side of the first top layer strip to the first side of the second top layer strip. The bottom layer 113 may include a first bottom layer strip of a phase-transition material (e.g. VO2) and a second bottom layer strip of the phase-transition material (e.g. VO2) spaced apart from the first bottom layer strip, e.g., strips 114. Each of the first bottom layer strip and the second bottom layer strip may include a first side (e.g. inner side) and an opposite second side (e.g. outer side). The first side of the first bottom layer strip may face towards the first side of the second bottom layer strip, the opposite second side of the first bottom layer strip may face away from the second bottom layer strip, and the opposite second side of the second bottom layer strip may face away from the first bottom layer strip. The bottom layer 113 may further include a plurality of bottom layer bands of the phase-transition material (e.g. VO2), e.g., bands 116, spaced apart from each other, each of the plurality of bottom layer bands extending from the first side of the first bottom layer strip to the first side of the second bottom layer strip. The bottom layer 113 may further include a plurality of bottom layer metal bands, e.g., bands 118, spaced apart from each other and interposed between the first side of the first bottom layer strip and the first side of the second bottom layer strip. Each of the plurality of bottom layer metal bands may also be spaced apart from: the first bottom layer strip, the second bottom layer strip, and the plurality of bottom layer bands.

In some embodiments, each of the first top layer strip, the second top layer strip, the first bottom layer strip, and the second bottom layer strip may extend substantially parallel to a same first axis (e.g., y-axis). In some embodiments, each of the plurality of top layer metal bands, the plurality of bottom layer bands of the phase-transition material, and the plurality of bottom layer metal bands may extend substantially parallel to a same second axis (e.g., x-axis). In some embodiments, the first axis and the second axis may be substantially perpendicular.

In some embodiments, each of the plurality of spaced apart protrusions of the phase-transition material, e.g., protrusions 106, protruding from the first top layer strip may be aligned with a respective one of the plurality of spaced apart protrusions protruding from the second top layer strip, and may also be aligned with a respective one of the plurality of top layer metal bands. In some embodiments, the plurality of top layer metal bands may be equally spaced from each other, the plurality of bottom layer bands of the phase-transition material may be equally spaced from each other, and the plurality of bottom layer metal bands may be equally spaced from each other.

In some embodiments, each of the first top layer strip, the second top layer strip, the first bottom layer strip, and the second bottom layer strip, may be in communication with an external stimulation device (e.g., an FPGA controller). In some embodiments, the unit cell may be configurable by the external stimulation device to switch between a first reflective state (e.g., first reflective state 100A), a different second reflective state (e.g., second reflective state 100B), and a third transmissive state (e.g., transmissive state 100C). In the first reflective state, the first top layer strip, the second top layer strip, the plurality of spaced apart protrusions, the first bottom layer strip, the second bottom layer strip, and the plurality of bottom layer bands may be in a metallic state, i.e., a conductive state. In the second reflective state, the first top layer strip, the second top layer strip, and the plurality of spaced apart protrusions may be in an insulator state, and the first bottom layer strip, the second bottom layer strip, and the plurality of bottom layer bands may be in the metallic state. In the third transmissive state, the first top layer strip, the second top layer strip, the plurality of spaced apart protrusions, the first bottom layer strip, the second bottom layer strip, and the plurality of bottom layer bands may be in the insulator state.

In some embodiments, the unit cell may be configured to interact with electromagnetic radiation having a frequency between 100 gigahertz and 10 terahertz.

In some embodiments, a metasurface may have a repeating pattern (e.g., lattice or grid) of unit cells, each unit cell structured as previously described. In some embodiments, for each unit cell: each of the first top layer strip, the second top layer strip, the first bottom layer strip, the second bottom layer strip, may extend substantially parallel to a same first axis (e.g., y-axis), and wherein each of the plurality of top layer metal bands, the plurality of bottom layer bands, and the plurality of bottom layer metal bands may extend substantially parallel to a same second axis (e.g., x-axis); the first axis and the second axis may be substantially perpendicular; and the repeating pattern of unit cells may comprise at least one column having a plurality of unit cells repeating in a direction of the first axis and at least one row having a plurality of unit cells repeating in a direction of the second axis.

In some embodiments, for the at least one column having the plurality of unit cells repeating in the direction of the first axis (e.g., y-axis): the first top layer strip of each unit cell in the at least one column may be connected to the first top layer strip of an adjacent unit cell in the at least one column; the second top layer strip of each unit cell in the at least one column may be connected to the second top layer strip of the adjacent unit cell in the at least one column; the first bottom layer strip of each unit cell in the at least one column may be connected to the first bottom layer strip of the adjacent unit cell in the at least one column; and the second bottom layer strip of each unit cell in the at least one column may be connected to the second bottom layer strip of the adjacent unit cell in the at least one column.

In some embodiments, each unit cell of the metasurface may be configurable by an external stimulation device (e.g., an FPGA controller) to switch between a first reflective state, a different second reflective state, and a third transmissive state as previously described.

In some embodiments, a period of unit cells in the direction of the first axis (e.g., y-axis) may be defined as a number of consecutive unit cells occurring in the direction of the first axis that are all in a same one of the first reflective state or the second reflective state, and groups of consecutive unit cells in the direction of the first axis may alternate between the first reflective state and the second reflective state according to the period (e.g., T_{y}). In some embodiments, a period of unit cells in the direction of the second axis (e.g., x-axis) may be defined as a number of consecutive unit cells occurring in the direction of the second axis that are all in a same one of the first reflective state or the second reflective state, and groups of consecutive unit cells in the direction of the second axis may alternate between the first reflective state and the second reflective state according to the period (e.g., Tx).

In some embodiments, for a given wavelength, different periods of unit cells in the direction of the first axis, different periods of unit cells in the direction of the second axis, and different periods of unit cells in the direction of the first axis and the second axis, may result in different beam reflection directions.

In some embodiments, the term “substantially parallel” is used herein, e.g. with reference to a strip or band being “substantially parallel” to an axis. The word “substantially” in this context is used to mean that the intention is for the strip or band to be generally parallel with the axis, but in actual implementation it might not be exactly parallel, e.g. some variation and/or error may be present, e.g. of +/−10%. When multiple strips or bands are referred to as being substantially parallel to a same axis, one, some, or all of those strips or bands might each be generally parallel to that axis within a variation, e.g. of +/−10%. The variation might be different for different strips and/or bands. The foregoing remarks also apply when one or more strips and/or bands and/or protrusions is/are referred to as being “substantially parallel” to something (such as to an edge of a unit cell) or “substantially parallel” to one another.

In some embodiments, the term “substantially perpendicular” is used herein, e.g. with reference to a first and second axis (e.g. x and y axis) being perpendicular to each other. The word “substantially” in this context is used to mean that the intention is for the two axes to be generally perpendicular, but in actual implementation they might not be exactly perpendicular, e.g. some variation and/or error may be present, e.g. of +/−10%. The foregoing remarks also apply when one or more strips and/or bands and/or protrusions is/are referred to as being “substantially perpendicular” to something (such as to an edge of a unit cell) or “substantially perpendicular” to one another.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A unit cell for a metasurface or metamaterial comprising:
a substrate comprising a top layer and a bottom layer, the top layer including:
a first top layer strip of vanadium dioxide and a second top layer strip of vanadium dioxide spaced apart from the first top layer strip of vanadium dioxide,
each of the first top layer strip of vanadium dioxide and the second top layer strip of vanadium dioxide including a first side and an opposite second side,
wherein the first side of the first top layer strip faces towards the first side of the second top layer strip, the opposite second side of the first top layer strip faces away from the second top layer strip, and the opposite second side of the second top layer strip faces away from the first top layer strip,
the opposite second side of the first top layer strip and the opposite second side of the second top layer strip each having a plurality of spaced apart protrusions of vanadium dioxide protruding therefrom, and
a plurality of top layer metal bands spaced apart from each other, each of the plurality of top layer metal bands extending from the first side of the first top layer strip to the first side of the second top layer strip; and
the bottom layer including:
a first bottom layer strip of vanadium dioxide and a second bottom layer strip of vanadium dioxide spaced apart from the first bottom layer strip of vanadium dioxide,
each of the first bottom layer strip of vanadium dioxide and the second bottom layer strip of vanadium dioxide including a first side and an opposite second side,
wherein the first side of the first bottom layer strip faces towards the first side of the second bottom layer strip, the opposite second side of the first bottom layer strip faces away from the second bottom layer strip, and the opposite second side of the second bottom layer strip faces away from the first bottom layer strip,
a plurality of bottom layer bands of vanadium dioxide spaced apart from each other, each of the plurality of bottom layer bands of vanadium dioxide extending from the first side of the first bottom layer strip of vanadium dioxide to the first side of the second bottom layer strip of vanadium dioxide; and
a plurality of bottom layer metal bands spaced apart from each other and interposed between the first side of the first bottom layer strip of vanadium dioxide and the first side of the second bottom layer strip of vanadium dioxide, each of the plurality of bottom layer metal bands spaced apart from the first bottom layer strip of vanadium dioxide, the second bottom layer strip of vanadium dioxide, and the plurality of bottom layer bands of vanadium dioxide.

2. The unit cell of claim 1, wherein each of the first top layer strip of vanadium dioxide, the second top layer strip of vanadium dioxide, the first bottom layer strip of vanadium dioxide, and the second bottom layer strip of vanadium dioxide extends substantially parallel to a first axis, and wherein each of the plurality of top layer metal bands, the plurality of bottom layer bands of vanadium dioxide, and the plurality of bottom layer metal bands extends substantially parallel to a second axis.

3. The unit cell of claim 2, wherein the first axis and the second axis are substantially perpendicular.

4. The unit cell of claim 1, wherein each of the plurality of spaced apart protrusions of vanadium dioxide protruding from the first top layer strip of vanadium dioxide is aligned with a respective spaced apart protrusion of the plurality of spaced apart protrusions of vanadium dioxide protruding from the second top layer strip of vanadium dioxide, and is aligned with a respective top layer metal band of the plurality of top layer metal bands.

5. The unit cell of claim 1, wherein the plurality of top layer metal bands are equally spaced from each other, the plurality of bottom layer bands of vanadium dioxide are equally spaced from each other, and the plurality of bottom layer metal bands are equally spaced from each other.

6. The unit cell of claim 1 wherein:
the opposite second side of the first top layer strip of vanadium dioxide and the opposite second side of the second top layer strip of vanadium dioxide each have five spaced apart protrusions of vanadium dioxide protruding therefrom;
the plurality of top layer metal bands comprises five bands;
the plurality of bottom layer bands of vanadium dioxide comprises three bands; and
the plurality of bottom layer metal bands comprises three bands.

7. The unit cell of claim 1, wherein each of the first top layer strip of vanadium dioxide, the second top layer strip of vanadium dioxide, the first bottom layer strip of vanadium dioxide, and the second bottom layer strip of vanadium dioxide is in communication with an external stimulation device.

8. The unit cell of claim 7, wherein the unit cell is configurable by the external stimulation device to switch between a first reflective state, a second reflective state different from the first reflective state, and a third transmissive state, and wherein:
in the first reflective state, the first top layer strip of vanadium dioxide, the second top layer strip of vanadium dioxide, the plurality of spaced apart protrusions of vanadium dioxide, the first bottom layer strip of vanadium dioxide, the second bottom layer strip of vanadium dioxide, and the plurality of bottom layer bands of vanadium dioxide are in a metallic state;
in the second reflective state, the first top layer strip of vanadium dioxide, the second top layer strip of vanadium dioxide, and the plurality of spaced apart protrusions of vanadium dioxide are in an insulator state, and the first bottom layer strip of vanadium dioxide, the second bottom layer strip of vanadium dioxide, and the plurality of bottom layer bands of vanadium dioxide are in the metallic state; and
in the third transmissive state, the first top layer strip of vanadium dioxide, the second top layer strip of vanadium dioxide, the plurality of spaced apart protrusions of vanadium dioxide, the first bottom layer strip of vanadium dioxide, the second bottom layer strip of vanadium dioxide, and the plurality of bottom layer bands of vanadium dioxide are in the insulator state.

9. The unit cell of claim 8, wherein, for a given wavelength, a phase difference between a first wave of electromagnetic radiation reflected by the unit cell in the first reflective state and a second wave of electromagnetic radiation reflected by the unit cell in the second reflective state is substantially pi radians.

10. The unit cell of claim 1, wherein the unit cell is configured to interact with electromagnetic radiation having a frequency between 100 gigahertz and 10 terahertz.

11. A metasurface having a repeating pattern of unit cells, each unit cell comprising:
a substrate comprising a top layer and a bottom layer, the top layer including:
a first top layer strip of vanadium dioxide and a second top layer strip of vanadium dioxide spaced apart from the first top layer strip of vanadium dioxide,
each of the first top layer strip of vanadium dioxide and the second top layer strip of vanadium dioxide including a first side and an opposite second side,
wherein the first side of the first top layer strip faces towards the first side of the second top layer strip, the opposite second side of the first top layer strip faces away from the second top layer strip, and the opposite second side of the second top layer strip faces away from the first top layer strip,
the opposite second side of the first top layer strip and the opposite second side of the second top layer strip each having a plurality of spaced apart protrusions of vanadium dioxide protruding therefrom, and
a plurality of top layer metal bands spaced apart from each other, each of the plurality of top layer metal bands extending from the first side of the first top layer strip to the first side of the second top layer strip; and
the bottom layer including:
a first bottom layer strip of vanadium dioxide and a second bottom layer strip of vanadium dioxide spaced apart from the first bottom layer strip of vanadium dioxide,
each of the first bottom layer strip of vanadium dioxide and the second bottom layer strip of vanadium dioxide including a first side and an opposite second side,
wherein the first side of the first bottom layer strip faces towards the first side of the second bottom layer strip, the opposite second side of the first bottom layer strip faces away from the second bottom layer strip, and the opposite second side of the second bottom layer strip faces away from the first bottom layer strip,
a plurality of bottom layer bands of vanadium dioxide spaced apart from each other, each of the plurality of bottom layer bands of vanadium dioxide extending from the first side of the first bottom layer strip of vanadium dioxide to the first side of the second bottom layer strip of vanadium dioxide; and
a plurality of bottom layer metal bands spaced apart from each other and interposed between the first side of the first bottom layer strip of vanadium dioxide and the first side of the second bottom layer strip of vanadium dioxide, each of the plurality of bottom layer metal bands also spaced apart from: the first bottom layer strip of vanadium dioxide, the second bottom layer strip of vanadium dioxide, and the plurality of bottom layer bands of vanadium dioxide.

12. The metasurface of claim 11,
wherein for each unit cell:
each of the first top layer strip of vanadium dioxide, the second top layer strip of vanadium dioxide, the first bottom layer strip of vanadium dioxide, and the second bottom layer strip of vanadium dioxide extends substantially parallel to a first axis, and wherein each of the plurality of top layer metal bands, the plurality of bottom layer bands of vanadium dioxide, and the plurality of bottom layer metal bands extends substantially parallel to a second axis; and
the first axis and the second axis are substantially perpendicular; and
wherein the repeating pattern of the unit cells comprises at least one column having a plurality of unit cells repeating in a first direction of the first axis and at least one row having a plurality of unit cells repeating in a second direction of the second axis.

13. The metasurface of claim 12, wherein for the at least one column having the plurality of unit cells repeating in the first direction of the first axis:
the first top layer strip of vanadium dioxide of each unit cell in the at least one column is connected to the first top layer strip of vanadium dioxide of an adjacent unit cell in the at least one column;
the second top layer strip of vanadium dioxide of each unit cell in the at least one column is connected to the second top layer strip of vanadium dioxide of the adjacent unit cell in the at least one column;
the first bottom layer strip of vanadium dioxide of each unit cell in the at least one column is connected to the first bottom layer strip of vanadium dioxide of the adjacent unit cell in the at least one column; and
the second bottom layer strip of vanadium dioxide of each unit cell in the at least one column is connected to the second bottom layer strip of vanadium dioxide of the adjacent unit cell in the at least one column.

14. The metasurface of claim 12, wherein each unit cell is configurable by an external stimulation device to switch between a first reflective state, a second reflective state different from the first reflective state, and a third transmissive state, and wherein:
in the first reflective state, the first top layer strip of vanadium dioxide, the second top layer strip of vanadium dioxide, the plurality of spaced apart protrusions of vanadium dioxide, the first bottom layer strip of vanadium dioxide, the second bottom layer strip of vanadium dioxide, and the plurality of bottom layer bands of vanadium dioxide are in a metallic state;
in the second reflective state, the first top layer strip of vanadium dioxide, the second top layer strip of vanadium dioxide, and the plurality of spaced apart protrusions of vanadium dioxide are in an insulator state, and the first bottom layer strip of vanadium dioxide, the second bottom layer strip of vanadium dioxide, and the plurality of bottom layer bands of vanadium dioxide are in the metallic state; and
in the third transmissive state, the first top layer strip of vanadium dioxide, the second top layer strip of vanadium dioxide, the plurality of spaced apart protrusions of vanadium dioxide, the first bottom layer strip of vanadium dioxide, the second bottom layer strip of vanadium dioxide, and the plurality of bottom layer bands of vanadium dioxide are in the insulator state.

15. The metasurface of claim 14, wherein a period of unit cells in the first direction of the first axis is defined as a number of consecutive unit cells occurring in the first direction of the first axis that are all in a same state of the first reflective state or the second reflective state, and wherein groups of consecutive unit cells in the first direction of the first axis alternate between the first reflective state and the second reflective state according to the period.

16. The metasurface of claim 14, wherein a period of unit cells in the second direction of the second axis is defined as a number of consecutive unit cells occurring in the second direction of the second axis that are all in a same state of the first reflective state or the second reflective state, and wherein groups of consecutive unit cells in the second direction of the second axis alternate between the first reflective state and the second reflective state according to the period.

17. The metasurface of claim 15, wherein the metasurface is configurable by the external stimulation device to alter the period of unit cells in the first direction of the first axis by altering the number of consecutive unit cells occurring in the first direction of the first axis that are all in the same state of the first reflective state or the second reflective state.

18. The metasurface of claim 16, wherein the metasurface is configurable by the external stimulation device to alter the period of unit cells in the second direction of the second axis by altering the number of consecutive unit cells occurring in the second direction of the second axis that are all in the same state of the first reflective state or the second reflective state.

19. The metasurface of claim 18, wherein, for a given wavelength, different periods of unit cells in the first direction of the first axis, different periods of unit cells in the second direction of the second axis, and different periods of unit cells in the first direction of the first axis and the second direction of the second axis, result in different beam reflection directions.

20. The metasurface of claim 14, wherein, for a given wavelength, a phase difference between a first wave of electromagnetic radiation reflected by the unit cell in the first reflective state and a second wave of electromagnetic radiation reflected by the unit cell in the second reflective state is substantially pi radians.
